(19) United States
(12) Patent Application Publication
(10) Pub. No.: US 2014/0126481 A1
(43) Pub. Date: May 8, 2014

(54) Block Scheduling Method For Scalable And Flexible Scheduling In A HSUPA System

(71) Applicant: NOKIA SIEMENS NETWORKS OY, Espoo (FI)

(72) Inventors: Naveen Arulselvan, Bangalore (IN); Harshit Pradip Sanghvi, Amedabad (IN); Vishnu Ram Omanakutty Amma Vijayaraghavan Nair, Bangalore (IN); Amal Pillai, Bangalore (IN)

(73) Assignee: Nokia Siemens Networks Oy, Espoo (FI)

(21) Appl. No.: 13/669,586

(22) Filed: Nov. 6, 2012

(51) Int. Cl. H04W 72/04; H04W 72/10

(52) U.S. Cl. CPC H04W 72/044; H04W 72/10
USPC 370/329

(57) ABSTRACT

A method for block scheduling of users is described. The method includes, in response to determining that a number of users in a wireless network exceed a threshold number, allotting the users into k block. The value of k is at least two. For each block, the method performs determining residual information for the block. The method also includes, for each block of the k blocks, loading into a fast-access memory user data for users in the block and scheduling the block in a scheduling period based at least in part on the user data and the residual information for k−1 other blocks. Apparatus and computer readable media are also described.

### TECHNICAL FIELD

The exemplary and non-limiting embodiments relate generally to wireless communication systems, methods, devices and computer programs and, more specifically, relate to block scheduling of users.

### BACKGROUND

This section is intended to provide a background or context. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

High speed uplink packet access (HSUPA) is becoming a preferred choice for both operators and end-users as HSUPA deployments are widespread and the supported data rates have increased exponentially. Until LTE deployments mature and acquire subscriber mass, the scalability of existing HSUPA deployments remains an important business consideration.

### SUMMARY

The below summary section is intended to be merely exemplary and non-limiting.

The foregoing and other problems are overcome, and other advantages are realized, by the use of the exemplary embodiments.

In a first aspect thereof an exemplary embodiment provides a method for block scheduling of users. The method includes, in response to determining that a number of users in a wireless network exceed a threshold number, allotting the users into k blocks. The value of k is at least two. For each block, the method performs determining residual information for the block. The method also includes, for each block of the k blocks, loading into a fast-access memory user data for users in the block and scheduling the block in a scheduling period based at least in part on the user data and the residual information for k−1 other blocks.

In a further aspect thereof an exemplary embodiment provides an apparatus is provided for block scheduling of users. The apparatus includes at least one processor and at least one memory storing computer program code. The at least one memory and the computer program code are configured to, with the at least one processor, cause the apparatus to perform actions. The actions include, in response to determining that a number of users in a wireless network exceed a threshold number, allotting the users into k blocks. The value of k is at least two. For each block, the actions include determining residual information for the block. The actions also include, for each block of the k blocks, loading into a fast-access memory user data for users in the block and scheduling the block in a scheduling period based at least in part on the user data and the residual information for k−1 other blocks.

In another aspect thereof an exemplary embodiment provides a computer readable medium is provided for block scheduling of users. The computer readable medium is tangibly encoded with a computer program executable by a processor to perform actions. The actions include, in response to determining that a specific criteria has been satisfied, (for example the number of users in a wireless network exceed a threshold number), allotting the users into k blocks. The value of k is at least two. For each block, the actions include determining residual information for the block. The actions also include, for each block of the k blocks, loading into a fast-access memory user data for users in the block and scheduling the block in a scheduling period based at least in part on the user data and the residual information for k−1 other blocks.

In a further aspect thereof an exemplary embodiment provides an apparatus is provided for block scheduling of users. The apparatus includes means for allotting the users into k blocks in response to determining that a specific criteria has been satisfied, for example the number of users in a wireless network exceed a threshold number. The value of k is at least two. The apparatus includes means for determining residual information for each block. The apparatus also includes means for loading into a fast-access memory user data for users in a given block and means for scheduling the given block in a scheduling period based at least in part on the user data and the residual information for k−1 other blocks.

### BRIEF DESCRIPTION OF THE DRAWINGS

The foregoing and other aspects of exemplary embodiments are made more evident in the following Detailed Description, when read in conjunction with the attached Drawing Figures, wherein:

FIG. 1 illustrates an exemplary centralized architecture of a radio access network.

FIG. 2 demonstrates the relationship of a scheduling epoch and scheduling periods in accordance with an exemplary embodiment.

FIG. 3 is a memory diagram that illustrates the operation of an exemplary method, and a result of execution of computer program instructions embodied on a computer readable memory, in accordance with various exemplary embodiments.

FIG. 4 is a logic flow diagram that illustrates the operation of an exemplary method, and a result of execution of computer program instructions embodied on a computer readable memory, in accordance with various exemplary embodiments.

FIG. 5 is a logic flow diagram that illustrates the operation of another exemplary method, and a result of execution of computer program instructions embodied on a computer readable memory, in accordance with various exemplary embodiments.

FIG. 6 shows a simplified block diagram of an exemplary electronic device that is suitable for use in practicing various exemplary embodiments.

### DETAILED DESCRIPTION

With the feature set and capabilities of HSUPA deployments being continually enhanced by the technology and standards, the limiting factor in HSUPA performance has shifted to the platform (such as the CPU and memory for example) and solution design. Innovative techniques are needed to address these limitations and to enable HSUPA to achieve its full potential.

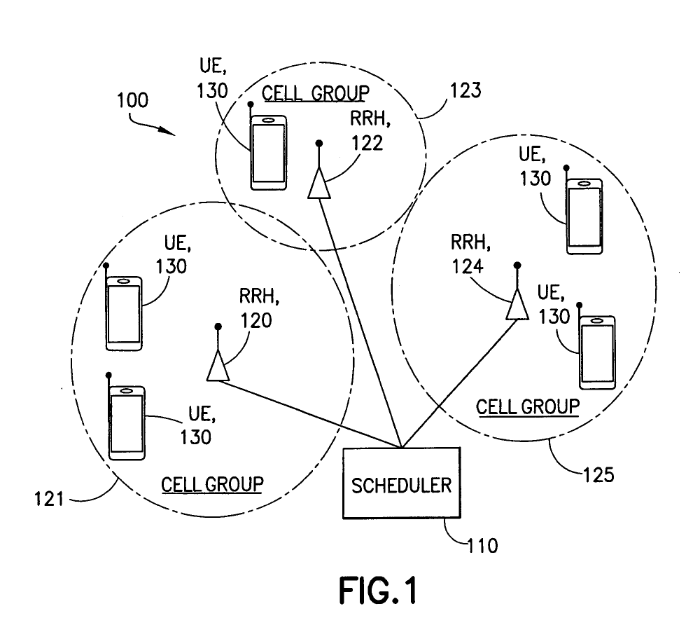

FIG. 1 illustrates an exemplary centralized architecture of a radio access network (RAN) 100 using a HSUPA deployment. The RAN 100 includes a centralized scheduler 110 which handles the scheduling for a plurality of radio resource heads (RRH) 120, 122, 124. One or more RRH 120, 122, 124 serve a Cell Group (CG) 121, 123, 125. Each CG 121, 123, 125 can serve a plurality of user equipment (UE) 130.

In a HSUPA Node B, the packet scheduler (PS) of a Cell Group (CG) may be centralized into a single master subsystem. In addition, an effective mechanism for hardware utilization may be provisioned in the form of resource manager (RM). User plane handling may be distributed among several slave subsystems, or clusters. Such a centralized framework offers several advantages such as optimal use of hardware resources to handle unequally loaded cells (referred to as dynamic deployment), maximization of softer-handover benefits for cell-edge users, etc. for example.

However, this centralized may also severely limit the capacity of the HSUPA system. For example, a scheduler can theoretically handle N UEs in a single CG (where one CG may consist of X cells) using a single core for processing. Yet actual implementations might only support only up to a*N UEs, where a<1 (e.g. a=0.5). This penalty in the capacity, a, is primarily due to memory constraints. The user-specific information needed for normal PS/RM operations has to be stored in the internal memory of the master subsystem. Unfortunately, the memory available is limited and further burdened by having to store application and common channel-related information. Even with system-on-chip (SoC)-based designs, the internal memory is limited. Additionally, new features are constantly being considered which increase the user-specific data that has to be stored.

Various exemplary embodiments provide techniques that actually meet the predicted HSUPA capacity while adhering to various guiding principles. These principles include a) being able to perform centralized scheduling operation in a scalable HSUPA architectural framework, and b) being able to replicate existing, conventional algorithm behavior such as grant allocation, congestion handling, load balancing, dynamic RM.

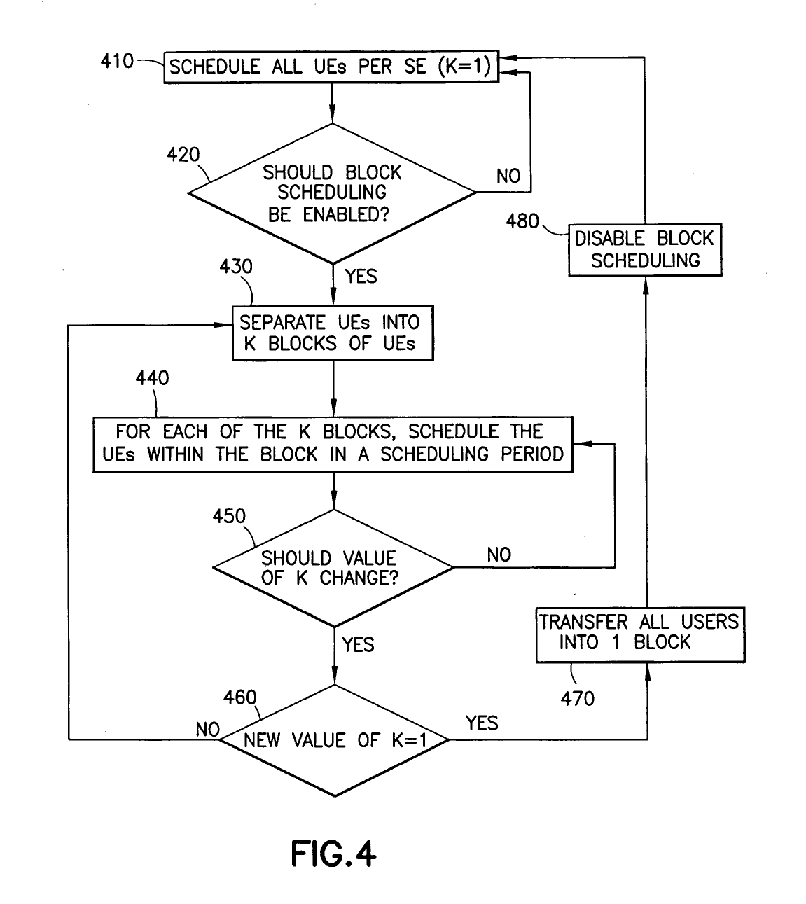

FIG. 4 is a logic flow diagram that illustrates the operation of an exemplary method, and a result of execution of computer program instructions embodied on a computer readable memory, in accordance with various exemplary embodiments. At block 410, all UEs are scheduled in each scheduling epoch (SE) in accordance with the conventional mode. At block 420, a determination is made as to whether block scheduling should be enabled (such as when additional UEs are received for example). If it is decided that block scheduling is not to be enabled (N), the process returns to block 410.

When block scheduling is to be enabled (Y), the process switches to a block scheduling mode. Transitioning to the block scheduling mode begins at block 430 where the UEs are separated into a plurality of k blocks. This may also include preparing data for the various blocks, such as residual data is representative of the constituent users in the associated block, for example.

At block 440, the block scheduling mode is in use. According to the block scheduling mode, for each of the blocks, the UEs with the block are scheduled in a scheduling period. A scheduling period is a 1/k portion of the SE used in the conventional mode such that k scheduling periods are equal to one SE.

At block 450, a determination is made as to whether the number of blocks (k) should be changed (such as, when UEs are received and/or dropped, system criteria are changed, etc., for example). If the current number of blocks is satisfactory and no change is determined (N), the process returns to the block scheduling mode of block 440.

If a new k is determined, at block 460, the new k is checked against a value of 1. If the value of k is greater than 1 (such that more than one block is to be used), the process returns to the block scheduling mode of block 440 using the new k value.

If the new k has a value of 1, the process continues to block 470 and transfers all uses into a single block. Next, the process disables block scheduling, at block 480. Then the process switches back to the conventional mode and returns to block 410 where all UEs are scheduled in each SE.

Various exemplary embodiments balance the conflicting objectives of centralized scheduling and scalability. Additionally, since processing elements are becoming cheaper, various exemplary embodiments enable increasing number of processing cores in order to use parallel processing, such as by having a first processing core perform scheduling operations on a first block and a second processing core perform scheduling operations on a second block during the same scheduling period, for example. Hence, it is possible to have a scalable and flexible scheme for scheduling users in the HSUPA system even while new constraints are taken into consideration. This will also be useful when preparing cloud architectures for next generation communication systems.

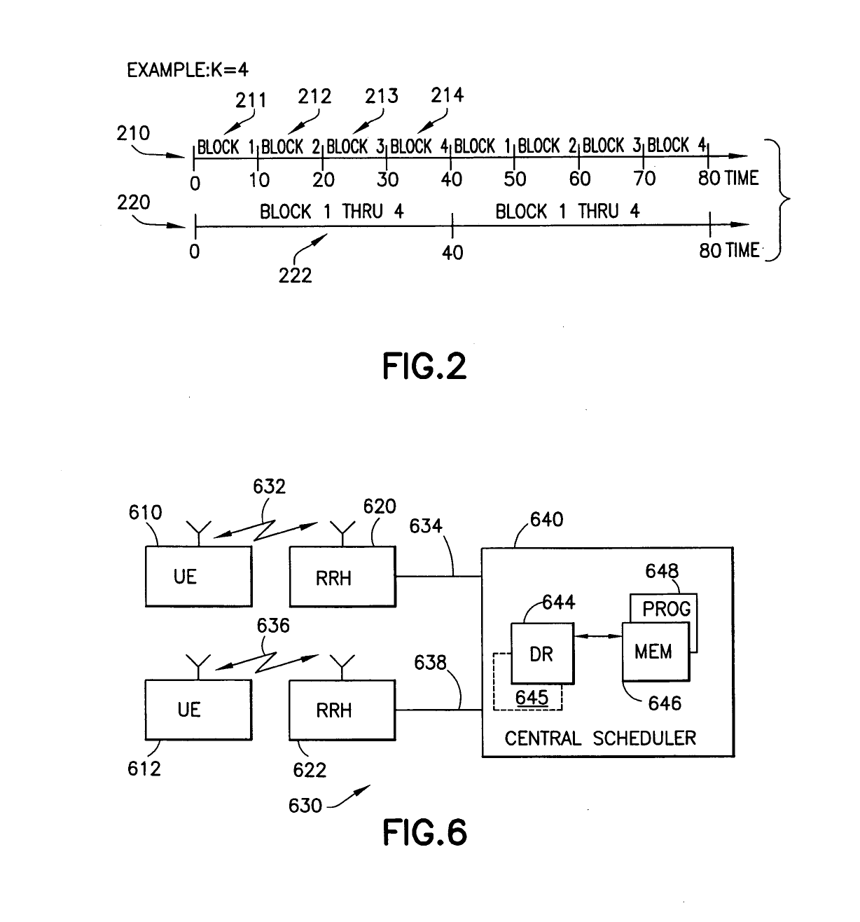

FIG. 2 demonstrates the relationship of a scheduling epoch 222 and scheduling periods 211, 212, 213, 214 in accordance with an exemplary embodiment. A first timeline 210 demonstrates a block scheduling embodiment where the scheduler 110 is configured to schedule individual blocks of users in each of the scheduling periods 211, 212, 213, 214, such as block 1 in scheduling period 211, block 2 in scheduling period 212, etc.

A second time 220 demonstrates a conventional scheduling mode where the scheduler 110 is configured to schedule all UEs 130 in a single scheduling epoch 222.

In this non-limiting embodiment, the users are divided into k=4 blocks. Thus, the scheduling epoch 222, which has a duration of 40 ms, is equal to k=4 scheduling periods 211, 212, 213, 214, each having a duration of 10 ms.

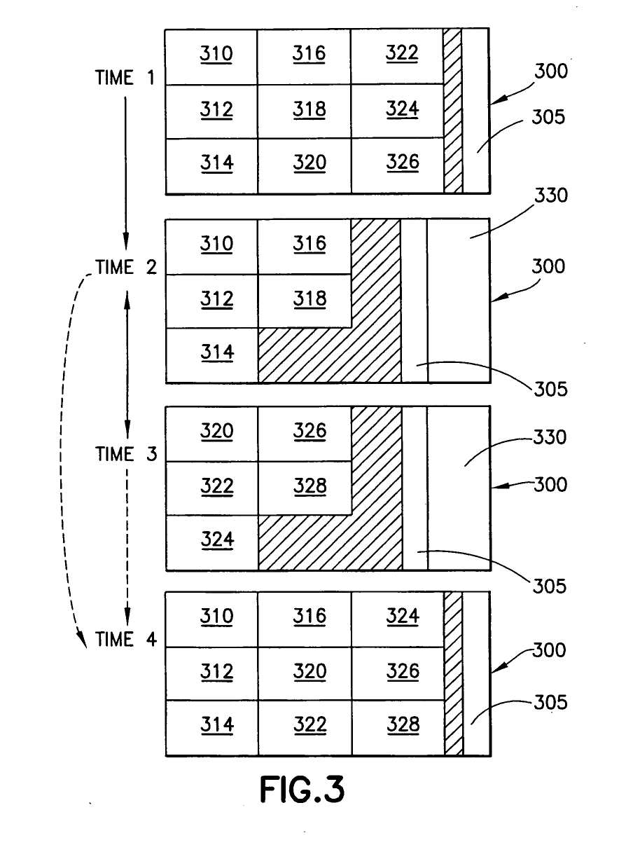

FIG. 3 is a memory diagram that illustrates the operation of an exemplary method, and a result of execution of computer program instructions embodied on a computer readable memory, in accordance with various exemplary embodiments. The memory 300 is shown as a single continuous element; however, this is for illustration purposes. Memory 300 may be distributed over one or more fast-access memory devices.

At a first time (Time 1), a fast-access memory 300 is shown storing user data 310-326 for 9 users and storing additional data 305 providing common data, cluster data and cell data. This represents the usage of memory 300 in accordance with a scheduler 110 operating in a conventional mode.

When the scheduler 110 is instructed to add an additional user, the scheduler determines whether the total number of users meets or exceeds a threshold limit. When the threshold limit is reached the scheduler 110 begins operating in a block scheduling mode. In this non-limiting example, the threshold limit is 10 users and two blocks are used.

At a second time (Time 2), the memory 300 is loaded with the additional data 305 and user data 310-318 for users in the first block. Additionally, memory 300 is loaded with residual data 330 representing all users. Thus, the scheduler 110 has access to the user data for users in the first block as well as the residual data of other users. Additionally, the residual data 330 regarding the present block is available for updating.

At a third time (Time 3), the memory 300 is still loaded with the additional data 305, the residual data 330. The user data 310-318 has been removed (or simply overwritten) and user data 320-328 is loaded.

The memory 300 is rotated between the set-ups so that the scheduler 110 has the data available for the appropriate scheduling period such that user data 310-318 is available when scheduling the first block and user data 320-328 is available when scheduling the second block. In this non-limiting embodiment, only two blocks are used; however, the techniques may be extended for more blocks.

At some later time (Time 4), the total number of users may no longer exceed the threshold limit, such as if the user associated with user data 318 is dropped for example, in which case, the scheduler 110 may transition to a conventional mode of scheduling. During this transition, the residual data 330 is removed from the memory 300 and the user data (310-316 and 320-328) for all active users is loaded into the memory 300. As before, the additional data 305 is maintained.

In another non-limiting embodiment, the threshold number of users used to determine when the transition to the conventional mode is to occur may be a different threshold (such as lower for example) than the threshold used to determine when to transition to the block scheduling mode.

Distributed scheduling has been the de facto mode of scheduler operation in traditional cellular systems. There are two primary reasons for this: (a) limited processing capability in legacy base stations (BTS) and (b) fractional frequency reuse employed in network planning, as a result cooperation needed across neighboring cells is limited. But with scarce spectrum availability for 3G/4G network deployments there is a demand for higher spectral efficiency. As a result frequency reuse of 1 is the common configuration and interference co-ordination across neighboring cells is used.

Along with advances in very-large-scale integration (VLSI) and multiple antenna technologies, cooperative communications across several cells are promising significant performance improvements. In such BTS designs, the packet scheduler (PS) functionality for a Cell Group (CG) is centralized into a single master subsystem, such as the scheduler 110. In addition, an effective mechanism for hardware utilization is provisioned in the form of a resource manager (RM). The baseband processing may be distributed among several slave subsystems/clusters which in turn act as “bit pipes”.

Such a centralized framework offers several advantages, such as providing an optimized use of hardware resources to handle unequally loaded cells (referred to as dynamic deployment), and enhanced throughput of for cell-edge users via cooperation, for example.

Based on the foregoing it should be apparent that various exemplary embodiments provide a method, apparatus and computer program(s) to enable block scheduling of users.

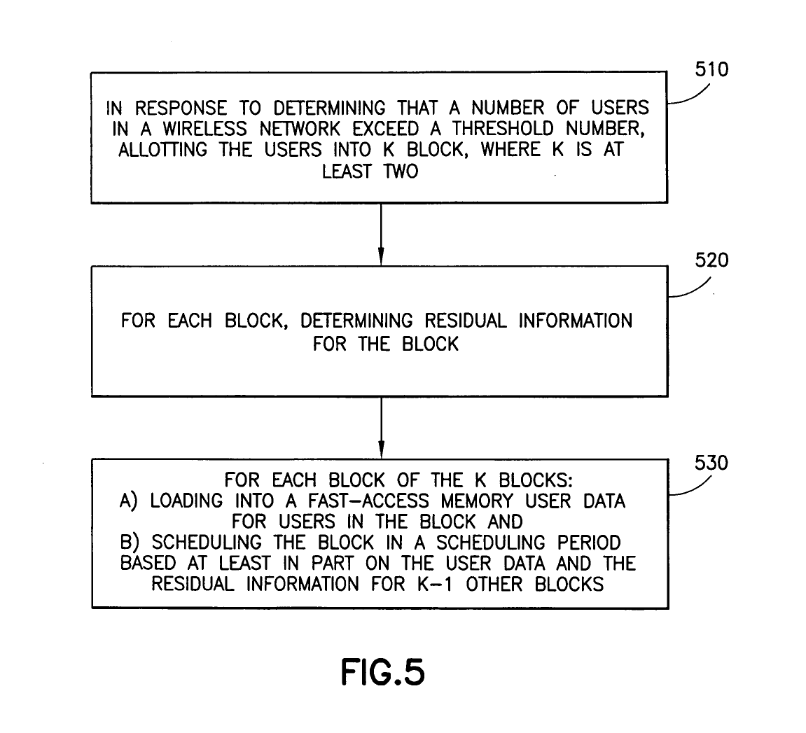

FIG. 5 is a logic flow diagram that illustrates the operation of a method, and a result of execution of computer program instructions, in accordance with exemplary embodiments. In accordance with these exemplary embodiments, in response to determining that a specific criteria has been satisfied, for example the number of users in a wireless network exceed a threshold number, a method performs, at Block 510, a step of allotting the users into k block, where k is at least two. For each of the k blocks, the method performs a step of determining residual information for the block, at Block 520. At Block 530, the method performs, for each block of the k blocks, a step of loading into a fast-access memory user data for users in the block and a step of scheduling the block in a scheduling period based at least in part on the user data and the residual information for k−1 other blocks.

Reference is made to FIG. 6 for illustrating a simplified block diagram of various electronic devices and apparatus that are suitable for use in practicing exemplary embodiments.

In the wireless system 630 of FIG. 6, a RAN is adapted for communication over a wireless links 634, 638 with apparatus, such as mobile communication devices which may be referred to as a UEs 610, 612, via network access nodes, such as a RRH 620, 622. The RAN includes a central scheduler 640 performs centralized scheduling for the UEs 610, 612.

The central scheduler 640 includes a controller, such as a computer or a data processor (DP) 644, a computer-readable memory medium embodied as a memory (MEM) 646 that stores a program of computer instructions (PROG) 648.

The PROG 648 is assumed to include program instructions that, when executed by the associated DP 644, enable the device to operate in accordance with exemplary embodiments. That is, various exemplary embodiments may be implemented at least in part by computer software executable by the DP 644 of the central scheduler 640, or by hardware, or by a combination of software and hardware (and firmware).

The central scheduler 640 may also include dedicated processors, for example scheduling processor 645.

In general, the various embodiments of the UE 610 can include, but are not limited to, cellular telephones, tablets having wireless communication capabilities, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances peimitting wireless Internet access and browsing, as well as portable units or terminals that incorporate combinations of such functions.

The computer readable MEM 646 may be of any type suitable to the local technical environment and may be implemented using any suitable data storage technology, such as semiconductor based memory devices, flash memory, magnetic memory devices and systems, optical memory devices and systems, fixed memory and removable memory. The DPs 644, 645 may be of any type suitable to the local technical environment, and may include one or more of general purpose computers, special purpose computers, microprocessors, digital signal processors (DSPs) and processors based on multicore processor architecture, as non-limiting examples.

The various blocks shown in FIGS. 4 and 5 may be viewed as method steps, and/or as operations that result from operation of computer program code, and/or as a plurality of coupled logic circuit elements constructed to carry out the associated function(s).

In a centralized scheduling mode for a CG for HSUPA systems, the PS/RM algorithms may use the current parameter information of all users in the system to evaluate load, available hardware resources etc. This “single-view” approach combined with the limitations in memory, severely handicaps the realizable capacity and flexibility of the scheduler.

The conventional algorithms process all users in every packet scheduling opportunity (such as in a single scheduling epoch for example). The duration of the PS epoch may be increased as the number of users increase. But there are several limitations with this approach, such as: 1) The single-view approach limits the number of users' whose context can be stored in the memory. 2) As advanced features are introduced, the user-specific context which is to be stored in the memory increases in size. As a result, rapid deployment and optimization of features is hampered. 3) As the fast-access memory (such as a Layer 2 cache for example) is limited, the processing unit is forced to access slow-access memory for the user data leading to frequent CPU stalls. 4) Even if additional processing elements are available, the system is not configured dynamically load-balance or utilize the best available computing resource.

As the processing elements (such as individual cores for example) become numerous and the use of distributed architecture increases (such as, an interconnected cloud architecture, for example), resource management (RM) is becoming an ever more complex task. When user processing is performed in multiple processing elements, RM decisions need to be made based on user parameters and cluster-specific information in every scheduling epoch (SE). Such a centralized RM algorithm, which matches the user demand against the available processing resources, will use processing and memory resources as well as accessing user data. The design of such systems should ensure that user data is available for RM processing as well as the memory and processing limitations that arise in RM operations, however conventional designs do not scale linearly with the number of users.

A trade-off is made between the fraction of resources utilized for scheduling and resource management operations, and the performance of the corresponding algorithms that operate on the relevant user information. Various exemplary embodiments achieve efficient trade-offs so that given a fixed set of resources (such as CPU, memory, etc. for example), user specific or feature processing is maximized while simultaneously maximizing the efficiency of PS and RM operations.

Until the number of users handled by the CG exceeds a configurable limit, the approach for scheduling users uses a conventional mode (such as, one where all users are processed in every SE for example). In other words, various exemplary embodiments use a block scheduling mode when the system load builds up and hence there is resource (memory/CPU) shortage.

In the block scheduling mode, the PS/RM operations are restricted to smaller user subsets called Blocks. A particular block of users is considered for scheduling in a given PS period (or scheduling period). The constituent users of the block could be based on one of several criteria depending on trade-offs desired by the system designer. For instance, blocks may be constructed based on the order of user arrival in the system which offers a simple implementation option. Other choices for building blocks include: user activity, traffic profile and/or user priority.

This pruning of the number of users for scheduling decision per PS period, translates to a reduction in resources used per scheduler execution (such as, memory requirements or CPU requirements, for example). Various exemplary embodiments utilizes only a fraction of the memory compared to the memory used in conventional techniques due in part on scheduling smaller subsets of users in a specific manner (such as, in a round-robin manner for example). In all, the memory savings could be as much as (k−1)/k where k is the total number of blocks.

While a subset of users is used for scheduling, representative information is maintained for the superset of users so that current scheduling decisions are not parochial. Thus, the sequence of current decision points in the legacy algorithm can be replicated, even though not all users are considered for scheduling.

There are several metrics calculated by the scheduler and resource manager by processing user-specific information of the entire user pool. As mentioned above, the block scheduling mode algorithms access one block of user's data at a time. But in order to mimic existing behavior, contributions from UEs in other k−1 blocks are used to account for accurate load measurements and hardware resource calculations. This provides safeguards to existing algorithms like load calculation and enforcing QoS fairness in scheduler decisions.

A dynamic or static configuration mechanism may be used to define the way constituents of a block are chosen. This configuration mechanism also allows the operator to give weights to the different types of blocks. As non-limiting examples, the types of blocks could be (a) random, (b) in the sequence of arrival of users in the system, (c) all (or a subset of) users from a given cell, (d) all (or a subset of) users from a given hardware cluster, (e) all (or subset of) low-activity users, (f) all (or subset of) high-activity users and (g) all (or subset of) high priority/low priority users.

The configuration mechanism may allow increases or decreases to in the representative data and the corresponding weight. As more representative data is used, more resources would also be utilized to hold it. However, the performance of the scheduler will align more with a legacy scheme where all users are considered in every SE.

The configuration mechanism also allows control of the size of the block. This may be defined in terms of number of users in a single block. The larger the number of user, more user data is accessed in the given PS period. At the same time, in order to achieve statistical multiplexing gains within a block, the number of users per block should be set reasonably high.

A block-aware, dynamic mechanism may be used for balancing the load between processing elements. This could be defined in terms of policies which govern the load balancing. Load balancing may involve movement of user processing from one cluster of processing elements to another. This movement could be done within an individual block or otherwise.

A configuration mechanism (either dynamic or static) may be used for setting the number of processing elements (cores) involved in the scheduler operation. This allows different blocks to be handled by different cores in parallel. Additionally, this enables the system to merge or collate the results from the different processing elements to form a final list of users and corresponding parameters which can be used for scheduling.

During a given scheduling period, the scheduler can operate on user in a subset U which is drawn from, X cells and Y clusters. The user, cell and cluster specific data per user may be stored in an external memory. The user memory pool is divided into k contiguous blocks with each block having N users. N is defined to be the maximum number of users that can be considered for PS/RM operation in scheduling period of t ms. This is equivalent to a performance target of processing N*k users in t*k ms.

Additionally, the savings in memory is approximately (k−1)/k % which is considerable for high capacity regimes. In such regimes, the N users in a given block will be drawn from all cells and clusters. In other words, the scheduler algorithms can operate on smaller user subsets which are representative of the actual user distribution in the individual cells/clusters respectively. This allows statistical multiplexing. Furthermore, these techniques can be readily extended to advanced board designs with multiple cores to parallelize the scheduler/RM operations.

Load Calculation

Aggregate statistical values may be used for the (k−1) dormant blocks based on the latest known information. This residual data is representative of the constituent users in each of the blocks. For instance, the load/interference caused by users in the current block i, may be calculated by:

$${L}_{load} ( i ) = {\sum }_{j = 1}^{M} f ( {P}_{j} ) . \qquad ( 1 )$$

Here Pj is the assigned transmission power for user j and f(.) maps power to interference load.

The latest known reserved load contributions from all other blocks are stored: L_{load}(i′). As a result the cumulative load for all users may be calculated by:

$${L}_{load , cell} = {L}_{load} ( i ) + {\sum }_{{i}^{′} \neq i}^{ } {L}_{load} ( {i}^{′} ) \qquad ( 2 )$$

The initial value of all dormant blocks may be set as L_{load,cell}(t₀)/k, where L_{load,cell}(t₀) is the estimate of initial load at time t₀ when the block scheduling mode is activated. Congestion load for a given cell and/or critical for normal scheduler operation may be similarly calculated. The usage of residual data is also applied to evaluate hardware indicating resource consumption. These metrics in turn, are useful when calculating the available hardware resources for new grants or when modifying existing grants.

QoS Fairness in Scheduler Decisions

Modifiable load may be calculated based on which users are upgraded/downgraded in a given PS period. The PS may stipulate a priority order in which these upgrades/downgrades are to happen. The priority order may depend on several factors, such as user's subscription information, current data rate etc. for example. As a non-limiting example, in a cell overload situation, bronze users are to be downgraded before gold users are impacted. In such situations, in order to avoid gold users from being downgraded out-of-turn when there are bronze user(s) present in one of the dormant k−1 blocks (those blocks not currently being scheduled), an indicator token is used. This token is passed around from block to block until the cell overload is alleviated.

Moreover, the metric of the top downgrade candidate in each block may be stored as residual data. Before downgrading a specific user, the user metric is compared with the top downgrade metrics of the (k−1) blocks. The downgrade operation may be suspended when there is a lower priority user present in another block. This ensures a higher priority user is not downgraded out-of-turn. In order to speed up convergence, a provision is provided for a configurable metric comparison factor Q (<1). The downgrade operation in a current block is suspended if the candidate's metric is less than Q*[highest metric from the other k−1 blocks].

Upgrades and load balancing/resource distribution in clusters may be handled similarly to the description for downgrade operations.

For example, a QoS flag may be used to indicate whether or not any block fails to fulfill the QoS requirements for the UE being served in that block. When scheduling a UE in one block the flag may be set so that when other blocks come up for scheduling they may release additional resources by downgrading one or more UEs (based on the presence of the flag and the priorities of the UEs) so that the unfulfilled QoS requirements may then be met.

Faster Handling of UE Feedback

In a non-limiting example, t UE feedback reports (such as, UL channel conditions or change in transmission parameters, for example) are generated in the span of 10*k msec. In a conventional mode, all t reports will be used for decisions in next scheduling epoch. However, in the block scheduling mode, as many as t*(1−1/k) reports will be available for use right away because of the staggered scheduling. As a result the block scheduling algorithm can utilize the feedback reports in a more timely manner.

An HSPA NodeB may implement a configurable upper water-mark (or threshold) for the number of users. When the number of users in the system crosses this water-mark, then the system begins using a block scheduling mode. When the number of users in the system drops below this water-mark, a conventional mode may be used to handle the low capacity. In a further non-limiting embodiment, the high capacity transition threshold is separate from the low capacity transition threshold. This avoids potential situations where the system fluctuates between modes.

In a non-limiting embodiment, the HSPA NodeB implements a mechanism by which the total number of users can be divided into blocks. The selection of users which form a block may be based on different criteria (such as, activity levels, priorities etc. for example). The HSPA NodeB serves these users in a block brought to memory “just-in-time” for the PS of that block. For example, the user data may be brought into a fast memory (Layer 2 memory, for example) of the core which is processing the block, just when the block comes up for scheduling. In each scheduling period, a block of users is served. This may be done using EDMA (Enhanced Direct Memory Access). Thus, the effective resources used for serving a large number of blocks of users is minimized.

A dynamic sorting mechanism may be used based on multiple weights. This could be similar to a standard list implementation. This sorting provides multiple views of the same data. Thus at any point of time, it is possible to identify the block with most active users, the block of highest priority users, and/or the block of users in their order of arrival in the system.

Block scheduling may be extended to multiple core processing. In a non-limiting example, each core can handle one (or more) of the blocks and the representative data is shared across cores.

A resource mapping may be used based on certain criteria to select a block to which the user is allocated (such as, when the user comes into the system for example). If the allocated block is not the current block, the data required for a user addition operation may be stored in the memory and the user is added when the allocated block becomes the current block. Similarly, when a user specific message is received in the scheduler, the system may consult the mapping function to decide whether the user is in current block. If not, the message may be buffered until the user's block becomes the current block.

Users in a block may belong to or be classified based on the clusters which process them. The users may then be load balanced within the cluster on a per block basis. Thus, the RM algorithm is applied according to policies on the users in clusters in the block.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although not limited thereto. While various aspects of the exemplary embodiments may be illustrated and described as block diagrams, flow charts, or using some other pictorial representation, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

It should thus be appreciated that at least some aspects of the exemplary embodiments may be practiced in various components such as integrated circuit chips and modules, and that the exemplary embodiments may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments.

Various modifications and adaptations to the foregoing exemplary embodiments may become apparent to those skilled in the relevant arts in view of the foregoing description, when read in conjunction with the accompanying drawings. However, any and all modifications will still fall within the scope of the non-limiting and exemplary embodiments.

For example, while the exemplary embodiments have been described above in the context of the E-UTRAN (UTRAN-LTE) system, it should be appreciated that the exemplary embodiments are not limited for use with only this one particular type of wireless communication system, and that they may be used to advantage in other wireless communication systems such as for example (WLAN, UTRAN, GSM as appropriate).

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

In an exemplary embodiment, a method is provided for block scheduling of users. The method includes, in response to deter mining (such as by a processor for example) that a number of users in a wireless network exceed a threshold number, allotting the users into k block. The value of k is at least two. For each block, the method performs determining (such as by a processor for example) residual information for the block. The method also includes, for each block of the k blocks, loading into a fast-access memory user data for users in the block and scheduling (such as by a processor for example) the block in a scheduling period based at least in part on the user data and the residual information for k−1 other blocks.

In a further exemplary embodiment of the method above, allotting the users into k blocks includes sorting the user based on an order of arrival of the users, activity of the users and/or priority of the users.

In another exemplary embodiment of any one of the methods above, scheduling the block is also based on a weight for each of the other k−1 blocks.

In a further exemplary embodiment of any one of the methods above, loading the user data for the users in the block includes loading into a first fast-access memory the user data for the users in a first block of the k blocks. The method also includes loading into a second fast-access memory the user data for users in a second block of the k blocks; and simultaneously scheduling, in the same scheduling period, the users in the first block in a first processor and scheduling the users in the second block in a second processor.

In another exemplary embodiment of any one of the methods above, the method also includes selecting a value of k such that a number of users in a block is approximately equal to a maximum number of users that can be scheduled in an individual scheduling period. The k scheduling periods are equal in length to a SE.

In a further exemplary embodiment of any one of the methods above, the residual information of a block includes a modification token indicating a top candidate user for a scheduling modification. Scheduling the block may include determining whether a top candidate user for the scheduling modification in the block being scheduled has a less appropriate priority than a candidate user for the scheduling modification indicated in a modification token for one of the other k−1 blocks. The method may also include, in response to determining that the top candidate user for the scheduling modification in the block being scheduled has a less appropriate priority than any candidate user for the scheduling modification indicated in a modification token for the other k−1 blocks, suspending the scheduling modification. The scheduling modification may be a downgrade and the less appropriate priority is a higher priority; the scheduling modification may be an upgrade and the less appropriate priority is a lower priority; the scheduling modification may be a load balancing operation and the less appropriate priority is a higher priority; and/or the scheduling modification may be a resource distribution operation and the less appropriate priority is a higher priority.

In another exemplary embodiment, an apparatus is provided for block scheduling of users. The apparatus includes at least one processor (such as DP 644 for example) and at least one memory (such as MEM 646 for example) storing computer program code (such as PROG 648 for example). The at least one memory and the computer program code are configured to, with the at least one processor, cause the apparatus to perform actions. The actions include, in response to determining that a number of users in a wireless network exceed a threshold number, allotting the users into k block. The value of k is at least two. For each block, the actions include determining residual information for the block. The actions also include, for each block of the k blocks, loading into a fast-access memory user data for users in the block and scheduling the block in a scheduling period based at least in part on the user data and the residual information for k−1 other blocks.

In a further exemplary embodiment of the apparatus above, allotting the users into k blocks includes sorting the user based on an order of arrival of the users, activity of the users and/or priority of the users.

In another exemplary embodiment of any one of the apparatus above, scheduling the block is also based on a weight for each of the other k−1 blocks.

In a further exemplary embodiment of any one of the apparatus above, loading into the fast-access memory the user data for the users in the block includes loading into a first fast-access memory the user data for the users in a first block of the k blocks. The actions also include loading into a second fast-access memory the user data for users in a second block of the k blocks; and simultaneously scheduling, in the same scheduling period, the users in the first block in a first processor and scheduling the users in the second block in a second processor.

In another exemplary embodiment of any one of the apparatus above, the actions also include selecting a value of k such that a number of users in a block is approximately equal to a maximum number of users that can be scheduled in an individual scheduling period. The k scheduling periods are equal in length to a SE.

In a further exemplary embodiment of any one of the apparatus above, residual information of a block includes a modification token indicating a top candidate user for a scheduling modification. Scheduling the block may include determining whether a top candidate user for the scheduling modification in the block being scheduled has a less appropriate priority than a candidate user for the scheduling modification indicated in a modification token for one of the other k−1 blocks. The actions may also include, in response to determining that the top candidate user for the scheduling modification in the block being scheduled has a less appropriate priority than any candidate user for the scheduling modification indicated in a modification token for the other k−1 blocks, suspending the scheduling modification. The scheduling modification may be a downgrade and the less appropriate priority is a higher priority; the scheduling modification may be an upgrade and the less appropriate priority is a lower priority; the scheduling modification may be a load balancing operation and the less appropriate priority is a higher priority; and/or the scheduling modification may be a resource distribution operation and the less appropriate priority is a higher priority.

In another exemplary embodiment of any one of the apparatus above, the apparatus is embodied in a mobile device.

In a further exemplary embodiment of any one of the apparatus above, the apparatus is embodied in an integrated circuit.

In another exemplary embodiment, a computer readable medium (such as MEM 646 for example) is provided for block scheduling of users. The computer readable medium is tangibly encoded with a computer program (such as PROG 648 for example) executable by a processor (such as DP 644 for example) to perform actions. The actions include, in response to determining that a number of users in a wireless network exceed a threshold number, allotting the users into k block. The value of k is at least two. For each block, the actions include determining residual information for the block. The actions also include, for each block of the k blocks, loading into a fast-access memory user data for users in the block and scheduling the block in a scheduling period based at least in part on the user data and the residual information for k−1 other blocks.

In a further exemplary embodiment of the computer readable medium above, allotting the users into k blocks includes sorting the user based on an order of arrival of the users, activity of the users and/or priority of the users.

In another exemplary embodiment of any one of the computer readable media above, scheduling the block is also based on a weight for each of the other k−1 blocks.

In a further exemplary embodiment of any one of the computer readable media above, loading into the fast-access memory the user data for the users in the block includes loading into a first fast-access memory the user data for the users in a first block of the k blocks. The actions also include loading into a second fast-access memory the user data for users in a second block of the k blocks; and simultaneously scheduling, in the same scheduling period, the users in the first block in a first processor and scheduling the users in the second block in a second processor.

In another exemplary embodiment of any one of the computer readable media above, the actions also include selecting a value of k such that a number of users in a block is approximately equal to a maximum number of users that can be scheduled in an individual scheduling period. The k scheduling periods are equal in length to a SE.

In a further exemplary embodiment of any one of the computer readable media above, residual information of a block includes a modification token indicating a top candidate user for a scheduling modification. Scheduling the block may include determining whether a top candidate user for the scheduling modification in the block being scheduled has a less appropriate priority than a candidate user for the scheduling modification indicated in a modification token for one of the other k−1 blocks. The actions may also include, in response to determining that the top candidate user for the scheduling modification in the block being scheduled has a less appropriate priority than any candidate user for the scheduling modification indicated in a modification token for the other k−1 blocks, suspending the scheduling modification. The scheduling modification may be a downgrade and the less appropriate priority is a higher priority; the scheduling modification may be an upgrade and the less appropriate priority is a lower priority; the scheduling modification may be a load balancing operation and the less appropriate priority is a higher priority; and/or the scheduling modification may be a resource distribution operation and the less appropriate priority is a higher priority.

In another exemplary embodiment of any one of the computer readable media above, the computer readable medium is a non-transitory computer readable medium (e.g., CD-ROM, RAM, flash memory, etc.).

In a further exemplary embodiment of any one of the computer readable media above, the computer readable medium is a storage medium.

In another exemplary embodiment, an apparatus is provided for block scheduling of users. The apparatus includes means for allotting (such as a processor for example) the users into k block in response to determining that a number of users in a wireless network exceed a threshold number. The value of k is at least two. The apparatus includes means for determining (such as a processor for example) residual information for each block. The apparatus also includes means for loading into a fast-access memory user data for users in a given block and means for scheduling (such as a processor for example) the given block in a scheduling period based at least in part on the user data and the residual information for k−1 other blocks.

In a further exemplary embodiment of the apparatus above, the allotting means includes means for sorting the user based on an order of arrival of the users, activity of the users and/or priority of the users.

In another exemplary embodiment of any one of the apparatus above, scheduling the block is also based on a weight for each of the other k−1 blocks.

In a further exemplary embodiment of any one of the apparatus above, the loading means includes means for loading into a first fast-access memory the user data for the users in a first block of the k blocks. The apparatus also includes means for loading into a second fast-access memory the user data for users in a second block of the k blocks; and means for simultaneously scheduling, in the same scheduling period, the users in the first block in a first processor and for scheduling the users in the second block in a second processor.

In another exemplary embodiment of any one of the apparatus above, the apparatus also includes means for selecting a value of k such that a number of users in a block is approximately equal to a maximum number of users that can be scheduled in an individual scheduling period. The k scheduling periods are equal in length to a SE.

In a further exemplary embodiment of any one of the apparatus above, residual information of a block includes a modification token indicating a top candidate user for a scheduling modification. The scheduling means includes means for determining whether a top candidate user for the scheduling modification in the block being scheduled has a less appropriate priority than a candidate user for the scheduling modification indicated in a modification token for one of the other k−1 blocks. The apparatus may also include means for suspending the scheduling modification in response to determining that the top candidate user for the scheduling modification in the block being scheduled has a less appropriate priority than any candidate user for the scheduling modification indicated in a modification token for the other k−1 blocks. The scheduling modification may be a downgrade and the less appropriate priority is a higher priority; the scheduling modification may be an upgrade and the less appropriate priority is a lower priority; the scheduling modification may be a load balancing operation and the less appropriate priority is a higher priority; and/or the scheduling modification may be a resource distribution operation and the less appropriate priority is a higher priority.

Furthermore, some of the features of the various non-limiting and exemplary embodiments may be used to advantage without the corresponding use of other features. As such, the foregoing description should be considered as merely illustrative of the principles, teachings and exemplary embodiments, and not in limitation thereof.

The following abbreviations that may be found in the specification and/or the drawing figures are defined as follows:

BTS base stations (e.g., an eNB)

CG cell group

EDCH enhanced dedicated channel

EDMA enhanced direct memory access

eNB E-UTRAN Node B (evolved Node B)

HARQ hybrid automatic repeat request

HSPA high speed packet access

HSUPA high speed uplink packet access

LTE long term evolution of UTRAN (E-UTRAN)

MIMO multiple input multiple output

MIPS million instructions per second

PS packet scheduler

RAN radio access network

RG relative grant

RL radio link

RM resource manager, resource management

RTWP received total wideband power

SE scheduling epoch

SoC system-on-chip

TTI transmission time interval

UE user equipment

UL uplink (UE towards eNB)

UTRAN universal terrestrial radio access network

VAF voice activity factor

VLSI very-large-scale integration

VoIP voice over IP

What is claimed is:

1. A method comprising:
in response to determining that a number of users in a wireless network exceed a threshold number, allotting the users into k block, where k is at least two;
for each block, determining residual information for the block; and
for each block of the k blocks, loading into a fast-access memory user data for users in the block and scheduling the block in a scheduling period based at least in part on the user data and the residual information for k−1 other blocks.

2. The method of claim 1, where allotting the users into k blocks comprises sorting the user based on at least one of the following criteria, but not limited to: an order of arrival of the users, activity of the users, traffic profile of the users and priority of the users.

3. The method of claim 1, where each block could be allocated a weight based on at least one of but not limited to: priority of the block, type of application data handled by users in that block, activity of users in the block and scheduling the block is further based on a weight for each of the other k−1 blocks.

4. The method of claim 1, where loading into the fast-access memory the user data for the users in the block comprises loading into a first fast-access memory the user data for the users in a first block of the k blocks and
the method further comprises:
loading into a second fast-access memory the user data for users in a second block of the k blocks; and
simultaneously scheduling, in the same scheduling period, the users in the first block in a first processor and scheduling the users in the second block in a second processor.

5. The method of claim 4, where the number of processors involved in processing the k blocks is configurable by the operator or determined dynamically.

6. The method of claim 1, further comprising selecting a value of k such that a number of users in a block is approximately equal to a maximum number of users that can be scheduled in an individual scheduling period,
where k scheduling periods are equal in length to a scheduling epoch.

7. The method of claim 1, where k blocks of users are already present in a wireless network and, in response to determining that a number of users in a wireless network is lower than a threshold number, x blocks are deleted, where x is at least one and at most k−1;
where each of the x blocks is selected based on but not limited to (a) least number of users among all the blocks, and (b) block with users of a particular category; and
where each user in x blocks is transferred to the other k−x blocks.

8. The method of claim 2, where k blocks of users are already present in a wireless network and, in response to a change in at least one sorting criterion, reallocating users across the k blocks.

9. The method of claim 7, where the number of blocks may be varied in response to the reallocation of users.

10. The method of claim 1, where the residual information of a block comprises a cumulative sum of resource consumption metrics based on at least one of but not limited to (a) cell load (b) buffer size and (c) processing cycles.

11. The method of claim 1, where the residual information of a block comprises a modification token indicating a top candidate user for a scheduling modification.

12. The method of claim 11, where scheduling the block comprises determining whether a top candidate user for the scheduling modification in the block being scheduled has a less appropriate priority than a candidate user for the scheduling modification indicated in a modification token for one of the other k−1 blocks.

13. The method of claim 12, further comprising, in response to determining that the top candidate user for the scheduling modification in the block being scheduled has a less appropriate priority than any candidate user for the scheduling modification indicated in a modification token for the other k−1 blocks, suspending the scheduling modification.

14. The method of claim 12, where one of:
the scheduling modification is a downgrade and the less appropriate priority is a higher priority;
the scheduling modification is an upgrade and the less appropriate priority is a lower priority;
the scheduling modification is a load balancing operation and the less appropriate priority is a higher priority; and
the scheduling modification is a resource distribution operation and the less appropriate priority is a higher priority.

15. An apparatus, comprising at least one processor; and at least one memory including computer program code, the at least one memory and the computer program code configured to, with the at least one processor, cause the apparatus to perform at least the following:
to allot the users into k block in response to determining that a number of users in a wireless network exceed a threshold number, where k is at least two;
for each block, to determine residual information for the block; and
for each block of the k blocks, to load into a fast-access memory user data for users in the block and to schedule the block in a scheduling period based at least in part on the user data and the residual information for k−1 other blocks.

16. The apparatus of claim 15, where, when loading into the fast-access memory the user data for the users in the block the at least one memory and the computer program code are further configured to cause the apparatus to load into a first fast-access memory the user data for the users in a first block of the k blocks;
to load into a second fast-access memory the user data for users in a second block of the k blocks; and
to simultaneously schedule, in the same scheduling period, the users in the first block in a first processor and scheduling the users in the second block in a second processor.

17. The apparatus of claim 15, where the at least one memory and the computer program code are further configured to cause the apparatus to select a value of k such that a number of users in a block is approximately equal to a maximum number of users that can be scheduled in an individual scheduling period,
where k scheduling periods are equal in length to a scheduling epoch.

18. A computer readable medium tangibly encoded with a computer program executable by a processor to perform actions comprising:
in response to determining that a number of users in a wireless network exceed a threshold number, allotting the users into k block, where k is at least two;
for each block, determining residual information for the block; and
for each block of the k blocks, loading into a fast-access memory user data for users in the block and scheduling the block in a scheduling period based at least in part on the user data and the residual information for k−1 other blocks.

19. The computer readable medium of claim 18, where loading into the fast-access memory the user data for the users in the block comprises loading into a first fast-access memory the user data for the users in a first block of the k blocks and
the actions further comprise:
loading into a second fast-access memory the user data for users in a second block of the k blocks; and
simultaneously scheduling, in the same scheduling period, the users in the first block in a first processor and scheduling the users in the second block in a second processor.

20. An apparatus comprising:
means for allotting the users into k block in response to determining that a number of users in a wireless network exceed a threshold number, where k is at least two;
means for determining, for each block, residual information for the block;
means for loading into a fast-access memory user data for users in a given block; and
means for scheduling the given block in a scheduling period based at least in part on the user data and the residual information for k−1 other blocks.

21. The apparatus of claim 20, where the loading means comprises means for loading into a first fast-access memory the user data for the users in a first block of the k blocks and
the apparatus further comprises:
means for loading into a second fast-access memory the user data for users in a second block of the k blocks; and
means for simultaneously scheduling, in the same scheduling period, the users in the first block and for scheduling the users in the second block.
